(19) United States
(12) Patent Application Publication
(10) Pub. No.: US 2012/0131570 A1
(43) Pub. Date: May 24, 2012

(54) METHOD AND APPARATUS FOR CUSTOMIZING DEVICE CONTENT

(75) Inventors: Markus Kaikkonen, Oulu (FI); Ville Alatalo, Oulu (FI)

(73) Assignee: Nokia Corporation, Espoo (FI)

(21) Appl. No.: 12/949,526

(22) Filed: Nov. 18, 2010

(51) Int. Cl. G06F 9/445

(52) U.S. Cl. 717/177; 717/174

(57) ABSTRACT

An approach is provided for customizing device content. A content manager receives an input for specifying one or more content items for a device. Next, the content manager determines to detect the device. Then, the content manager determines to initiate installation of the one or more content items at the device based, at least in part, on the detection

### BACKGROUND

Service providers and device manufacturers (e.g., wireless, cellular, etc.) are continually challenged to deliver value and convenience to consumers by, for example, providing compelling network services. One area of interest has been development of services for customizing a user device including the external look of the device as well as the user interface and software of the device. However, such customization services and/or related tools often are dependent on extensive user interaction and can be quite burdensome and time-consuming to the user. This burden can often degrade the user experience associated with the customization process and discourage users from taking advantage of available customization options. In particular, when users first purchase a new device (e.g., a new mobile phone), it is noted that users often do not want to spend a significant amount of time or effort customizing the new device, but would rather proceed to use the device for its intended functions. Accordingly, service providers and device manufacturers face significant technical challenges in enabling users to more customize and/or obtain content for user devices.

### Some Example Embodiments

Therefore, there is a need for an approach for efficiently customizing device content while minimizing user burden.

According to one embodiment, a method comprises receiving an input for specifying one or more content items for a device. The method also comprises determining to detect the device. The method further comprises determining to initiate installation of the one or more content items at the device based, at least in part, on the detection.

According to another embodiment, an apparatus comprises at least one processor, and at least one memory including computer program code, the at least one memory and the computer program code configured to, with the at least one processor, cause, at least in part, the apparatus to receive an input for specifying one or more content items for a device. The apparatus is also caused to determine to detect the device. The apparatus is further caused to determine to initiate installation of the one or more content items at the device based, at least in part, on the detection.

According to another embodiment, a computer-readable storage medium carries one or more sequences of one or more instructions which, when executed by one or more processors, cause, at least in part, an apparatus to receive an input for specifying one or more content items for a device. The apparatus is also caused to determine to detect the device. The apparatus is further caused to determine to initiate installation of the one or more content items at the device based, at least in part, on the detection.

According to another embodiment, an apparatus comprises means for receiving an input for specifying one or more content items for a device. The apparatus also comprises means for determining to detect the device. The apparatus further comprises means for determining to initiate installation of the one or more content items at the device based, at least in part, on the detection.

According to another embodiment, a method comprises facilitating access to at least one interface configured to allow access to at least one service, the at least one service configured to receive an input for specifying one or more content items for a device. The at least one service is also configured to determine to detect the device. The at least one service is further configured to determine to initiate installation of the one or more content items at the device based, at least in part, on the detection.

According to another embodiment, a computer program product including one or more sequences of one or more instructions which, when executed by one or more processors, cause an apparatus to receive an input for specifying one or more content items for a device. The apparatus is also caused to determine to detect the device. The apparatus is further caused to determine to initiate installation of the one or more content items at the device based, at least in part, on the detection.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of customizing device content, according to one embodiment;

FIG. 2 is a diagram of the components of a content manager, according to one embodiment;

FIG. 3 is a flowchart of a process for customizing device content, according to one embodiment;

FIG. 4 is a flowchart of a process for utilizing a user account for customizing device content, according to one embodiment;

FIG. 5 is a diagram of an overall process of customizing device content, according to one embodiment;

FIGS. 6A-6B are diagrams of web interface of a service utilized in the processes of FIG. 3, according to one embodiment;

FIGS. 7A-7C are diagrams of user interfaces of an user equipment utilized in the processes of FIG. 3, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for customizing device content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

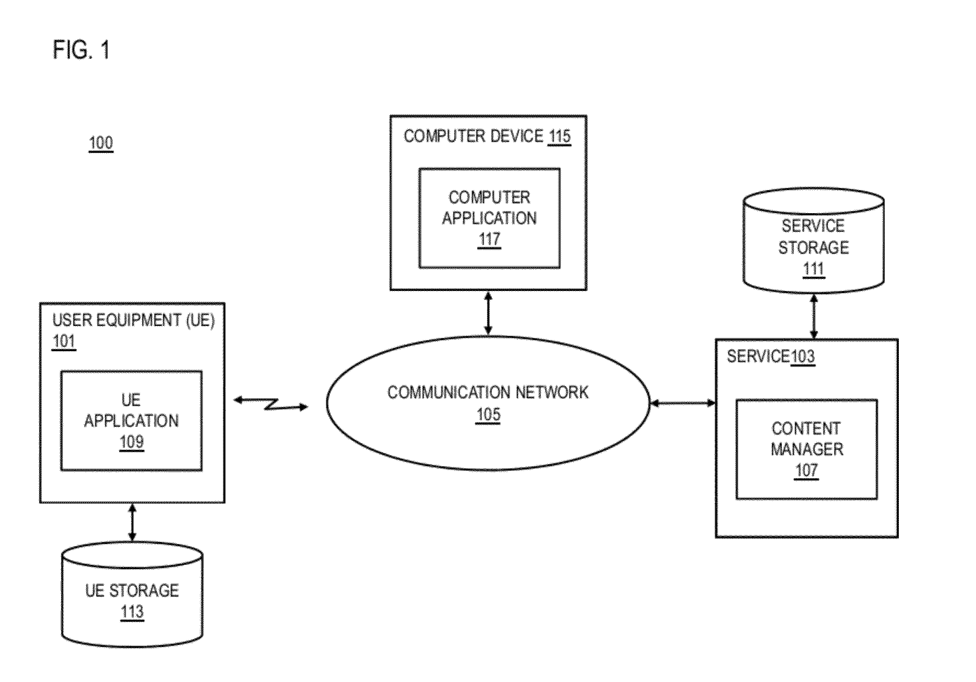

FIG. 1 is a diagram of a system capable of customizing device content, according to one embodiment. As discussed previously, it may take considerable effort and time to select and install desired content (e.g., software applications, components, themes, etc.) to customize a user device. In particular, when a user purchases or first starts using a new device, the user may need to perform multiple tasks to customize the settings and personalize the user interface, software, etc. Examples of customization and personalizing may include setting themes, background images, ringing tones, downloading and installing favorite applications, etc. Many users may find these processes to be complicated and time-consuming, and thus may have difficult time customizing their user devices according to their preferences. The users may also find that it is difficult to customize using a user interface of the user device because the user device may not provide effective user interface for the customization, particularly when the user device is a mobile device with limited features and/or a small display screen. Further, it may be desirable to be able to complete the customization at a point of sale (e.g. a store where the user buys the device), instead of waiting to perform the customization until later. In addition, if the user does not complete the customization soon after purchasing the device, the user may not perform the customization later because the user may find the customization process to be difficult. Thus, the user may continue using the device without customization, although the customization may provide optimal user experience with the device. Therefore, an easy and effective way to provide the content to customize the device according to user preferences is desired.

To address this problem, a system 100 of FIG. 1 introduces the capability to customize device content by remotely specifying content items for a user device and then downloading the specified content items to the user device. In one embodiment, the system 100 receives an input for specifying one or more content items to customize, transfer, and/or install at a device. By way of example, the content items may be software content (e.g. applications and games), media content (e.g. wallpaper image, sound), or other content available to the device. For instance, the source of the content may be one or more service providers, content providers, network operators, device manufacturers, and the like. In one embodiment, a user may specify the content items via a web browser or another application that have connectivity to the source(s) of the content. By way of example, the source may wait until the device becomes available (e.g. is turned on) to transmit the specified content items from the source to the device for installation. The system 100 then detects the device, and then determines to initiate installation of the one or more content items at the device based on the detection. The device may be detected when the device is connected via a communication network. The installation of the content items may be initiated by automatically transmitting the content items to the device.

In one sample use case, when a user first purchases a user device from a store, the user may be provided with an option of customizing the user device at the point of the sale. The store may have a computer or a touch pad device with a user interface having connectivity to a service for customizing device content. This enables the user to customize the device content remotely at the point of purchase of the device, for example. The user may first create a user account for the service using the computer at the store. If the user already has a user account, the user may log into the user account at the service, using the user interface of the computer at the store. The user account may be associated with the user device such that the service may be able to communicate with the user device based on the information of the user account. Once logged into the user account, the user may select content items available on the service for the user device customization, via the computer at the store. Then, the user may turn on the user device for the first time after the purchase. The user device may request the user to enter the user name and a password which correspond to the user account for the service and which are authenticated by the service with respect to the user account. When the user device is turned on and establishes a connection with the service via a communication network, the service detects the device and transmits the selected content items to the device. Instead of transmitting the selected content items, the service may also transmit links that can be used to download the content items. When the content items are downloaded to the user device, the user device installs the content items and customizes the user device according to the downloaded content items.

As shown in FIG. 1, the system 100 comprises a user equipment (UE) 101 having connectivity to a service 103 via a communication network 105. The service 103 may use the content manager 107 of the service 103 to communicate with the UE 101. Thus, the content manager 107 may initiate installation of the specified content items at the UE 101 via the UE application 109, upon detection of the UE 101, and cause the UE application 109 to install the selected content items. The service storage 111 may be used to store content items that can be selected for the installation. Also, the UE storage 113 may be used to store the content item received from the service 103. The initiation of the installation may include identifying the specified content items and the corresponding device (e.g. UE 101), such that the specified content items and/or the links to the specified content items may be transmitted to the device for installation. In addition, a computer device 115 may also have connectivity to the service 103 as well as the UE 101. The computer device 115 may be used to access the service 103 to enter an input to specify content items to be sent to the UE 101. For example, the content manager 107 of the service 103 may communicate with the computer device 115 to present available content items at the computer device 115. The computer device 115 may have a computer application 117 such as a web browser to connect to the service 103 and to display on the computer application 117 a user interface (e.g. web interface) with the content items available in the service 103. Then, a user may use the user interface displayed via the computer application 117 to select content items to be installed at the UE 101. The computer device 115 may generally be located at a point of sale of the UE 101. For example, the computer device 115 may be a computer at a store that sells the UE 101. Then, the user may purchase the UE 101 at the store, and select the content items using the computer device 115 at the store right after the purchase. This enables the user to easily select the content items to install at the UE 101. The computer device 115 may also be any computer with a web browsing capability. Then, the user can use the user's personal computer to connect to the service 103, and specify the content items using the user interface.

The initiation of the installation may include transmitting the content items from the service 103 to the UE 101. After the content items are transmitted to the UE 101, the installation of the content items may be performed at the UE 101. Additionally or alternatively, the initiation of the installation may include transmitting links from the service 103 to the UE 101, wherein the links can be used to retrieve the content items. Then, to complete the installation, the service 103 causes actions that result in retrieval of the content items via the links, and installation of the retrieved content items at the UE 101. The links may direct the UE 101 to the service 103 or other sources to download the content items to the UE 101. In one embodiment, the service 103 may determine characteristics of the content items. Then, based on the characteristics, the content items may be sent to the UE 101 or links to the content items may be sent to the UE 101. The characteristics may include the size and type of the content item, priority rating of the content item, etc. In one example, if the service 103 determines that the size of the content item to be installed at the UE 101 is too large to transmit from the service 103 to the UE 101, the service 103 may determine to transmit the link to the content item to the UE 101, instead transmitting the content item to the UE 101. Then, the UE 101 may use the information in the link to download the content item to the UE 101 from a source specified in the link, wherein the source may be the service 103 or other services or online databases, for example. Further, in one embodiment, the initiation of the installation of the content items and/or the installation itself at the UE 101 may be performed without any notification or indication to the user of the UE 101. Thus, the installation of the content items may be performed at the UE 101 without having the user notice that the installation is initiated and/or is in process. This initiation of the installation may also include utilizing a push notification service (not shown), wherein the content items and/or the links to the content items are pushed from the service 103 to the UE 101 via the push notification service. Because some push notification service has a limit on the size of the data to be pushed, a link to the content item may be pushed to the UE 101 if the content item is too big to be pushed to the UE 101.

In one embodiment, the system 100 may associate the content items with an account associated with the UE 101. When the account becomes active over the communication network 105, the service receives a notification that the account is active. The account may be active when a user turns on the UE 101 and signs into the account for the UE 101. Thus, the detection of the UE 101 by the service 103 may be based on the detection of this notification. The user may create an account associated with the UE 101, and select the content items under the account. In one example, the computer application 117 may request the user to sign into the user account of the service 103, wherein the user account is associated with the UE 101. Thus, the user account of the service 103 may be specific for the UE 101, and the content manager 107 may display only the content items that are compatible with the UE 101.

In one embodiment, the service 103 may determine to generate a user interface for presenting options associated with specifying of the content items. The user interface may be a web interface that the computer device 115 can access using a web browsing capability of the computer application 117. Then, using the user interface, the user can browse the content items available at the service 103 and specifies the content items. The user interface may have various features in addition to the features enabling the users to specify the content items for the UE 101. For example, the user interface may include ratings and reviews for the content items as well as descriptions of the content items. The user interface may also include prices of the content items and payment means, if the content items are not free. In one embodiment, the service may also determine to request via this user interface approval information for the installation. Some content may need approval and/or acceptance of agreements, licenses, etc. from the user to be installed at the UE 101. Thus, the input for specifying the content item may also include an input associated with the approval information. Then, the user may read the approval information such as user agreements via the user interface, and then chooses to approve or disapprove the installation of the user contents. In this way, the subsequent push installation of the content items at the device can proceed without interruption or need for user input.

Therefore, an advantage of this approach is that by providing a user a way to customize the user device via the service and having the service initiating the customization of the device, the user does not have to go through a cumbersome manual process of customization using the device after the device is purchased. For example, the user can specify the content items to be installed at the user device via the service using a device at a point of purchase of the user device, such that customization of the user device using the content items can be performed automatically as the device is detected by the service. Because this approach enables the user to install content items in the user device without much effort according to the user's preferences, the user has more incentive to customize the device.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, service 103 and the computer device 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

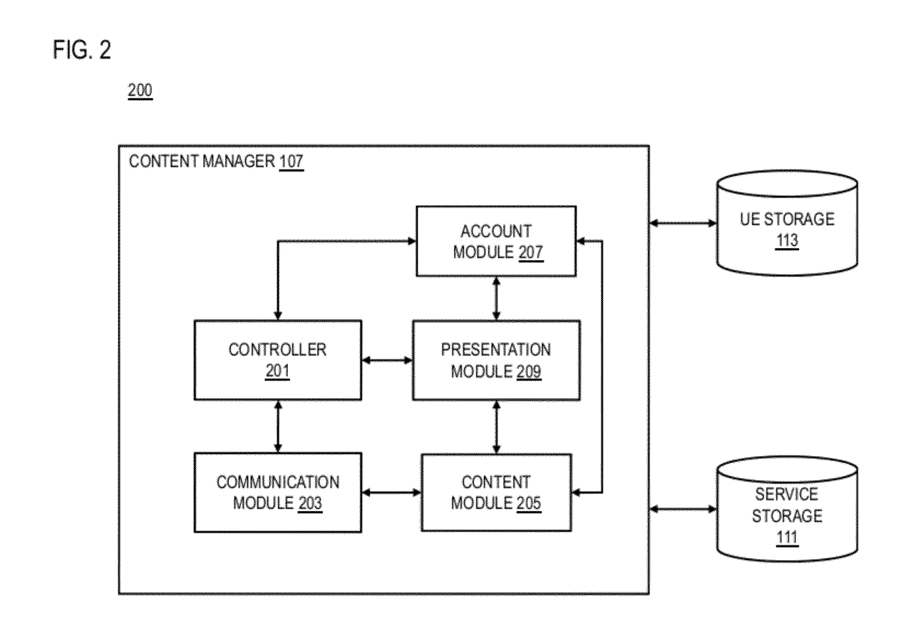

FIG. 2 is a diagram of the components of the content manager 107, according to one embodiment. By way of example, the content manager 107 includes one or more components for customizing device content. It is contemplated that the functions of these components may be combined in one or more components or performed by other components of equivalent functionality. In this embodiment, the content manager 107 includes a controller 201, a communication module 203, a content module 205, an account module 207 and a presentation module 209. The control module 201 oversees tasks, including tasks performed by the communication module 203, the content module 205, the account module 207 and the presentation module 209. The communication module 203 is used for communication between the service 103 and the computer device 115 as well as the UE 101, to exchange data such as the content items and information related thereto. The communication module may also be used to communicate between the service 103 and the service storage 111. The content module 205 manages the content items available in the service 103. The account module 207 may contain information about the user of the UE 101 as well as the UE 101 itself. The content module 205 may communicate with the account module 207 to determine which content items are compatible with the UE 101. The presentation module 209 may be used to present the available content items for selection to the computer device 115. The presentation module 209 may be capable of providing a user interface, such as a web interface, that can be accessed via a software application such as a web browser.

In one embodiment, the communication module 203 receives an input for specifying the content items for the UE 101. The input may be entered via the computer device 115, and may be communicated to the communication module 203 of the service 103. The communication module 203 may also detect the UE 101, as the UE 101 becomes available on the communication network 105. The input for specifying the content items is sent to the content module 205. Then, the content module 205 may determine to initiate installation of the specified content items at the UE 101, based on the detection of the UE 101. Thus, once the UE 101 is active over the communication network 105, the installation of the content items may be initiated at the UE 101.

In one embodiment, the content module 205 may determine to associate the specified content items with the account associated with the UE 101, by communicating with the account module 207. For example, the specified content items may be specifically for the account associated with the UE 101. Then, as the communication module 203 receives a notification that the account is active over the communication network 105, the detection of the UE 101 may be based on the notification of the account being active. By way of example, a user may activate the UE 101 that automatically signs into the account, and then the account becomes active online over the communication network 105. As the account becomes active online, the communication network 105 may receive the notification of the active account. The input for specifying the content item may be received on a sale, an activation, a remote management event, or a combination thereof of the UE 101. For example, when a user first purchases the UE 101 and activates the UE 101 at a store where the user made the purchase or a kiosk that supports the UE 101, the user may use a computer or a touchpad device (e.g. the computer device 115) to enter the input for specifying the content item.

In one embodiment, the initiation of the installation includes determining to transmit the specified content items to the UE 101. The initiation of the installation may also include determining to transmit links to the specified content items to the UE 101. If the links are transmitted to the UE 101, then the initiation of the installation may also include causing actions that result in retrieval and the installation of the content items in the UE 101, using the links. For example, the content module 205 may determine to cause the UE 101 to download the specified content items from the service 103 or any other sources of the content items as indicated by the links. The transmission of the content items and/or the links to the content items may be performed via the communication module 203. In another embodiment, the content module 205 may determine characteristics of the content items, and determine whether to transmit the links or the content items based on the characteristics. The characteristics may include the size and type of the content items as well as priority rating of the content items. For example, if the size of the content item is too big for efficient transmission from the service 103 to the UE 101, then the content module 205 may determine to transmit the link to the content item instead of transmitting the content item, such that the UE 101 may use the link to download the content item. As another example, if the priority rating of the content item is high, the content module 205 may transmit the content item itself to the UE 101, instead of providing the link. Further, the content module 205 may transmit the content item or the link for the content item with the highest priority rating first and then transmit the content item or the link for the content item with a lower priority rating. In addition, the initiation of the installation of the content items and/or the installation of the content items may be performed without generating a notification of such initiation and/or installation to the user of the UE 101. This may be advantageous in that the user may not be interrupted by receiving a notification about the initiation of the installation and/or installation.

Further, in one embodiment, the presentation module 209 may generate a user interface for presenting options associated with the specifying of the content items. For example, the user interface may be provided to the computer device 115 such that the user interface may be accessed via the computer application 117. Then, the user may utilize the user interface at the computer device 115 to select the content items for the UE 101. The user interface may be a web interface that may be accessed by a web browser, and the computer application 117 may have the web browser capability to access the web interface. The presentation module 209 may also request via this user interface approval information for the installation of the specified content items. The approval information may be presented to the user via the user interface such that the installation of the content items may be performed only after the user agrees to the approval information. The approval information may be various forms of agreements such as an end user license agreement (EULA).

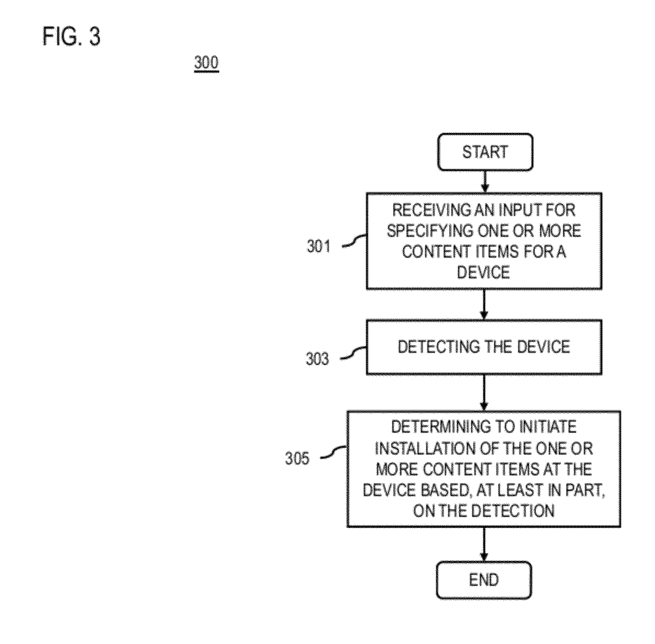

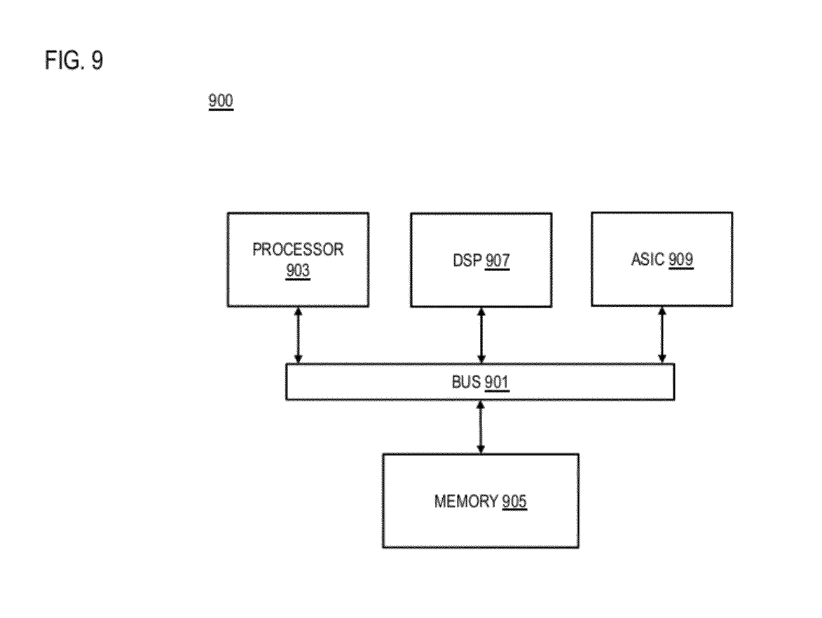

FIG. 3 is a flowchart of a process for customizing device content, according to one embodiment. In one embodiment, the content manager 107 performs the process 300 and is implemented in, for instance, a chip set including a processor and a memory as shown in FIG. 9. In step 301, the content manager 107 receives an input for specifying content items for a device (e.g. the UE 101). Examples of the content items may include themes, backgrounds, color, sounds or any other type of data that can be used to customize the device. This input may be received on a sale, an activation and/or a remote management event of the device. For example, the user may use the computer device 115 to enter the input for specifying the content items, wherein the computer device 115 may be presented at the store where the device is purchased and/or a kiosk for supporting the device. In this example, the user is able to customize the device remotely at the computer device 115 by selecting the content items, instead of performing customization directly at the device. The input may be entered via a user interface provided by the content manager 107 to another device such as the computer device 115. For example, the content manager 107 may generate a user interface for presenting options associated with the specifying of the content items. The user interface may be presented to the computer device 115 such that the user may use the user interface displayed on the computer device 115 via the computer application 117. The user interface may display available content items for selection, and the user may interact with the user interface to specify the content items for the device. In one example, the user interface may be a web interface that can be viewed using a web browsing capability of the computer application 117.

Further, the content manager 107 may determine to request via the user interface approval information for the installation of the specified content items. For example, the content manager 107 may present the approval information on a user interface displayed at the computer device 115, such that the user may view the approval information. The user may also enter an input to indicate that the user agrees to the approval information. The approval information may include a user agreement such as the end user licensing agreement. Thus, in one embodiment, the content items may be installed at the user's device only after the use agrees to the approval information.

In step 303, the content manager 107 detects the device. The content manager 107 may detect the device as the device is turned on and is active over the communication network 105. Once the device is detected, the content manager 107 determines to initiate installation of the content items at the device based on the detection, as shown in step 305. In one example, the UE 101 may already be turned on and active over the network, before the content items are specified. Then, as soon as the content manager 107 receives the input for specifying the content items, the specified content items may be transmitted to the UE 101. If the content items are specified first, then the transmission of the content items to the UE 101 may not occur until the user turns on the UE 101 and activates the UE 101 over the network.

The initiation of the installation may include determining to transmit the content items from the service 103 to the device (e.g. the UE 101). Once the content items are transmitted to the device, the content items may be installed at the device. In addition or alternatively, the initiation of the installation may include determining to transmit links to the content items from the service 103 to the device (e.g. the UE 101), and then causing actions that result in the retrieval and the installation of the content items at the device. The content manager 107 may determine whether to transmit the content items from the service 103 or the links to the content items from the service, based on the characteristics of the content items. The characteristics of the content items may include size, type of the content items as well as priority associated with the content items. By way of example, if the initiation of the installation is performed via a push notification service from the service 103 to the device (e.g., the UE 101), then it may not be desirable to utilize the push notification service for a large data. Thus, if the size of the content item is large, the link to the content item may be transmitted to the device via the push notification service, and then the device may retrieve the content item based on the link. Further, based on the type or the priority rating, the order of the transmission for the content items and/or the links to the content items may be determined. For example, the content item with the highest priority rating may be transmitted to the device first, before other content items are transmitted.

This process is advantageous in that it provides an easy way to initiate and perform installation of the content items at the device according to the user's specified content items. The content manager 107 is a means for achieving this advantage.

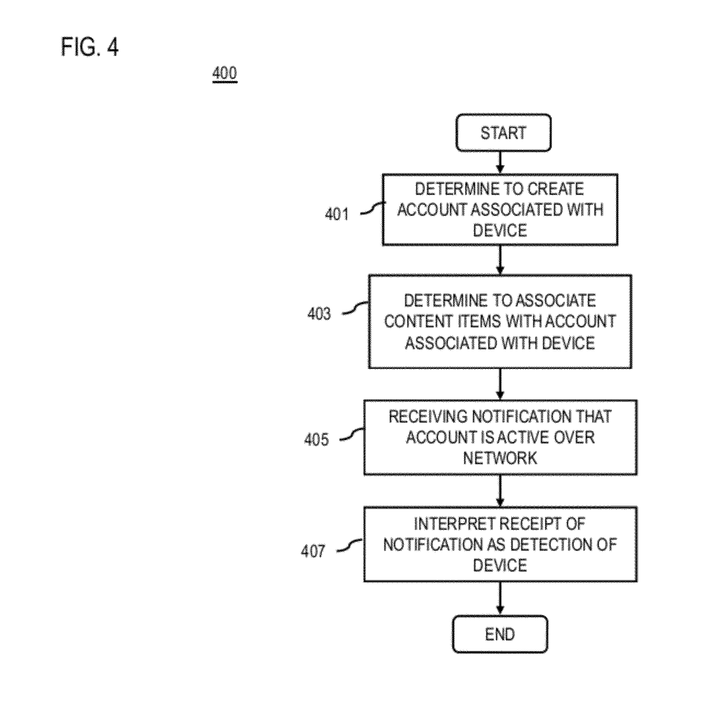

FIG. 4 is a flowchart of a process for utilizing a user account for customizing device content, according to one embodiment. In one embodiment, the content manager 107 performs the process 300 and is implemented in, for instance, a chip set including a processor and a memory as shown in FIG. 9. In step 401, the content manager 107 determines to create an account associated with the device (i.e. UE 101). For example, the user may create an account via the computer application 117 showing the user interface provided by the service 103. The information provided by the user in creation of the account may be stored in the service 103. As the user provides information about the UE 101, the user interface may provide content items available specifically for the UE 101. This may help the user specify the content items that are compatible with the device. In step 403, the content manager 107 determines to associate the content items with the account associated with the device. As the content items are associated with the account, the activation of the account may trigger installation of the content items at the device. Thus, in step 405, the content manager 107 receives a notification that the account is active over a network, and then in step 407, the content manager 107 interprets the receipt of the notification as the detection of the device. For example, as the user turns on the UE 101, the UE 101 signs into the account, which then becomes active over the network. The detection of this active account is considered as the detection of the UE 101, and thus the detection of the active account may initiate the installation of the content items.

This process is advantageous in that it provides a way to maintain a user account to provide easy selection of the content items for the device and convenient detection of the device based on the detection of the active user account over the network. The content manager 107 is a means for achieving this advantage.

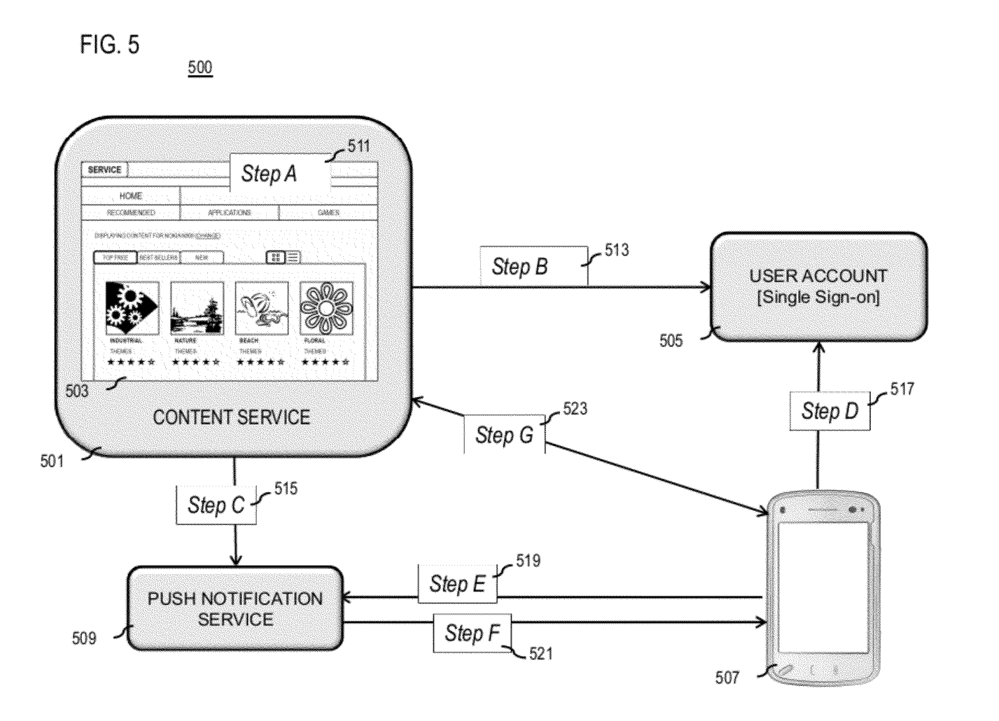

FIG. 5 is a diagram of an overall process of customizing device content, according to one embodiment. This diagram 500 shows an interaction among a content service 501 with the user interface 503, a service account 505, a user device 507 and a push notification service 509, according to one embodiment of the invention. The content service 501 and the user device 507 are equivalent to the service 103 and the UE 101 of FIG. 1. In step A 511, after the user purchases the user equipment, the user may use the user interface 503 presented by the service 501 to the store computer, for example, in order to specify the content items to install at the user device 507. In step B 513, the user may create a user account for the service 501 using the user interface 503 and sign into the user account 505. After step A 511 and step B 513 are completed, the user has specified content items for the user account 505. In step C 515, the specified content items or the links to the specified content items are transmitted to the push notification service 509. In step D 517, when the user turns on the user device 507, the user device 507 also signs into the user account. Then, the content service 501 detects that the user device 507 is active. The user may also register the user device 507 with the push notification service 509, in step E 519. Then, upon the detection of the user device 507, the push notification service 509 pushes the specified content items or the links to the specified content items to the user device, in step F 521. If the links to the specified content items are pushed to the user device 507, then the user device 507 downloads the content items from the content service 501 using the links, in step G 523. Once the content items are retrieved at the user device 507, the user device 507 installs the content items to customize the user device 507. Step C, step E and step F that involve the push notification service 509 steps are optional steps. Instead of involving the push notification service 509, the user device 507 may download the specified content items or the links to the specified content items directly from the content service 501, when the device 507 is turned on and is detected by the content service 501.

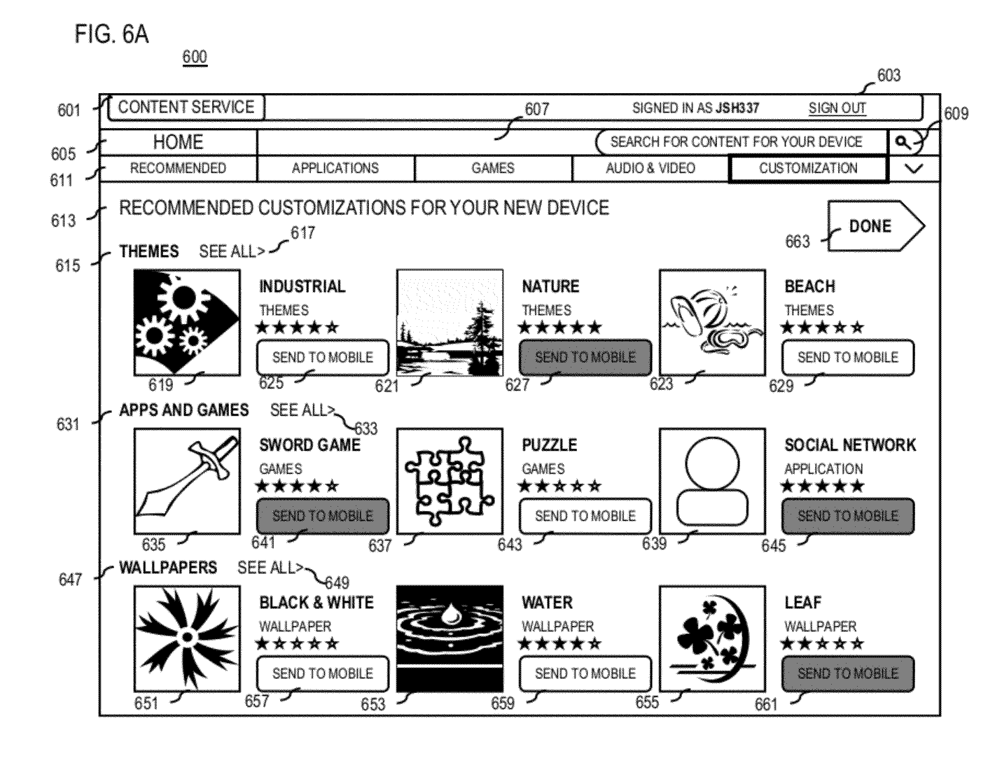

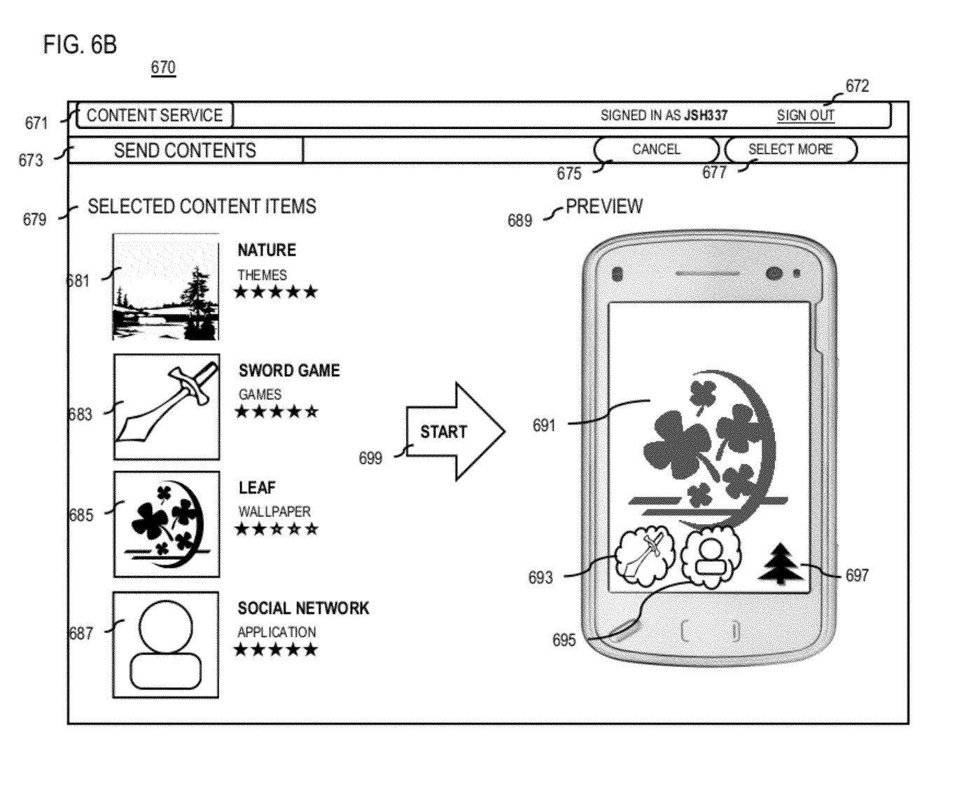

FIGS. 6A-6B are diagrams of web interface of the service 103 utilized in the processes of FIG. 3, according to one embodiment. FIG. 6A shows a web interface 600 displaying content items that are available for selection. The title section 601 shows that this web interface 600 is by a content service. The title section 601 also shows that the web interface 600 has a user ID JSH337 signed in, and also has a sign out option 603. The page name section 605 indicates that the page that the web interface displays is “home”. The search bar 603 may be used to enter a keyword for searching for content for the UE 101, and the search is conducted based on the keyword if the search button 609 is selected. The menu bar 611 shows five different options (recommended, applications, games, audio & video and customization) for displaying content, and indicates that customization option is selected. Thus, the description section 613 shows that the page shows content items recommended for customization for the UE 101.

In the description section 613, the themes section 615 has a see all button 617 to show all available themes, and displays three recommended themes. In this case, the recommended themes are an industrial theme 619, a nature theme 621, a beach theme 623, and the three themes have ratings in the number of stars. There are also send to mobile buttons 625, 627 and 629 corresponding to the industrial theme 619, the nature theme 621 and the beach theme 623, respectively. The send to mobile button 627 is highlighted, as the nature theme 737 is selected. The send to mobile buttons 625, 627 and 629 may be selected to select a theme to send to the UE 101. The apps and games section 631 displays recommended applications and/or games, and also has a see all button 633 to show all available applications and games. In this example, the recommended applications and games include a sword game 635, a puzzle game 637 and a social network application 639, and these three have ratings in the number of stars. There are also send to mobile buttons 641, 643 and 645 corresponding to the sword game 635, the puzzle game 637 and the social network application 639. The send to mobile buttons 641 and 645 are highlighted, as the sword game 635 and the social network application 645 are selected. Further, the wallpapers section 647 shows three recommended wallpapers, and also has a see all button 649 to show all available wallpapers. The three recommended wallpapers in this example are a black & white wallpaper 651, a water wallpaper 653 and a leaf wallpaper 655, and these three wall papers have ratings in the number of stars. There are also send to mobile buttons 657, 659 and 661 corresponding to the black & white wallpaper 651, the water wallpaper 653 and the leaf wallpaper 655. The send to mobile button 661 is highlighted as the leaf wallpaper 655 is selected. When the selections are done, then the done button 663 to show a list of the selected content items and a preview, as shown in FIG. 6B.

FIG. 6B shows a web interface 670 that shows a list of the selected items and a preview of the selected items installed in the UE 101. The title section 671 shows that this web interface 670 is by a content service. The title section 601 also shows that the web interface 600 has a user ID JSH337 signed in and further has a sign out option 672. The page name section 673 shows that the web interface 670 is for sending content items to the UE 101, and has a cancel button 675 to cancel sending of the content items as well as a select more button 677 to go back to the web interface 600 of FIG. 6A to select more content items. The list of the selected content items 679 shows the nature theme 681, the sword game 683, the leaf wallpaper 685 and the social network application 687. The preview 689 section shows the UE 101 with the selected content items installed. The preview section 689 shows a leaf wallpaper 691 installed as a background. Also, the sword game icon 693 and the social network application 695 icon are displayed, as the sword game 683 and the social network application 687 are installed. These icons 693 and 695 are in a cloud shape because the nature theme 681 is installed. Also, the main menu button 697 is in a tree shape because the nature theme 681 is installed.

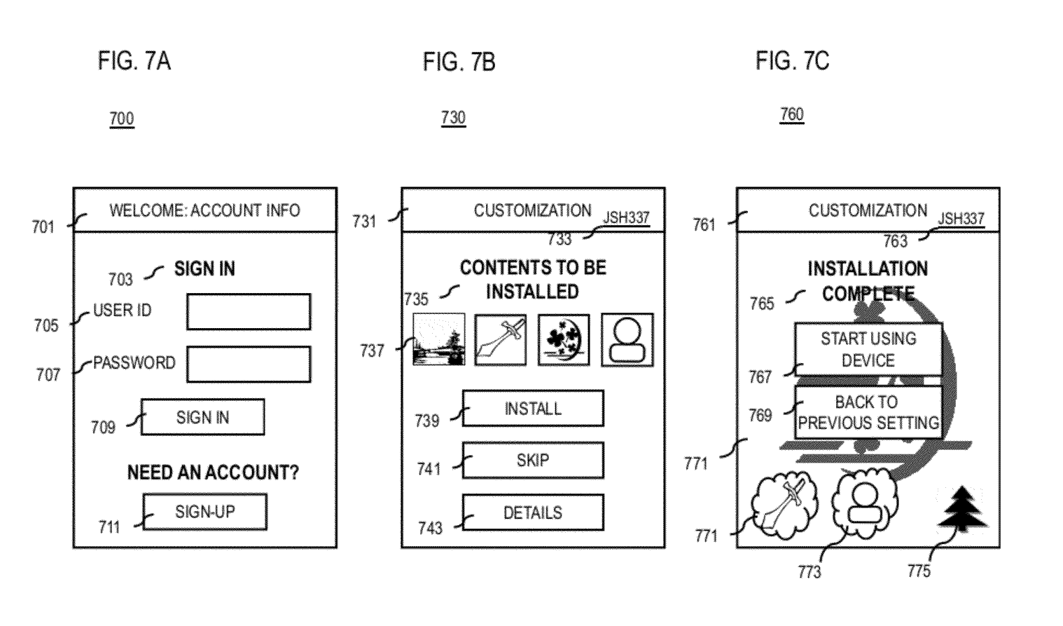

FIGS. 7A-7C are diagrams of user interfaces of the UE 101 utilized in the processes of FIG. 3, according to one embodiment. FIG. 7A shows a user interface 700 requesting to enter the user account information to sign in. This user interface 700 may be displayed when the UE 101 is first turned on after the purchase of the UE 101. The title section 701 indicates that the user interface 700 is for entering the user account information. The sign-in section 703 has a user ID portion 705 to enter the user ID for the account, and a password portion 707 to enter a corresponding password. The sign in button 709 may be selected after the user ID and the password are entered in the user ID portion 705 and the password portion 707, respectively. If the user does not have a user account, then the sign up button 711 may be selected to sign up for a user account. FIG. 7B shows a user interface 730 showing a notification that the service 103 has communicated with the UE 101 to cause installation of the content items at the UE 101. The title section 731 shows that the user interface 730 is for displaying customization process of the UE 101. The title section 731 also shows that the user signed in as the user name JSH337 indicated at 733. The notification section 735 shows that there are content items to be installed. The content section 737 shows icons of the content items to be installed. The install button 739 proceeds with the installation to customize the UE 101 based on these content items. The skip button 741 skips the installation and proceeds to the default settings for the UE 101. The details button 743 shows the details about the content items to be installed. FIG. 7C shows a user interface 760 after the installation of the content items is complete. The title section 761 shows that the user interface 730 is for displaying customization process of the UE 101, and also shows that the user signed in as the user name JSH337 indicated at 763. The installation complete message 765 indicates that the content items have been installed. The start using device button 767 may be selected to start using the device with the installed content items. The back to previous setting button 769 may be selected to revert back to the setting before installing the content items. The background of the user interface 760 shows a leaf background 771, similar to the leaf wallpaper 691. Further, the sword game icon 771 and the social network application 773 icon are displayed. These icons 771 and 773 are in a cloud shape because the nature theme is installed. Also, the main menu button 775 is in a tree shape because the nature theme is installed.

The processes described herein for customizing device content may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

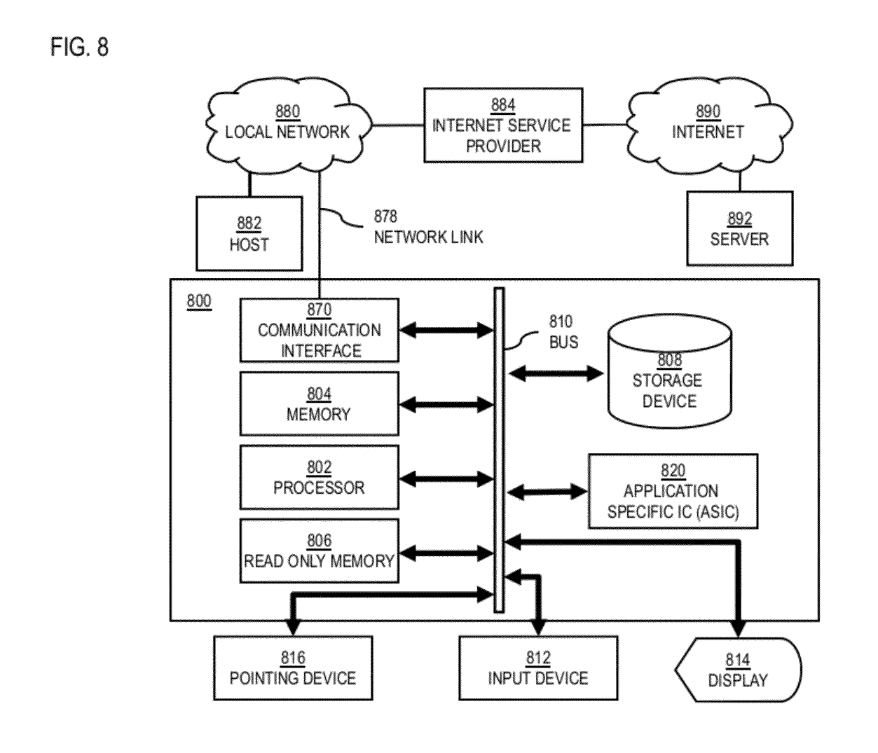

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to customize device content as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of customizing device content.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to customizing device content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for customizing device content. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for customizing device content, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for customizing device content.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to customize device content as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of customizing device content according to user preferences.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to customize device content. The memory 905 also stores the data associated with or generated by the execution of the inventive steps.

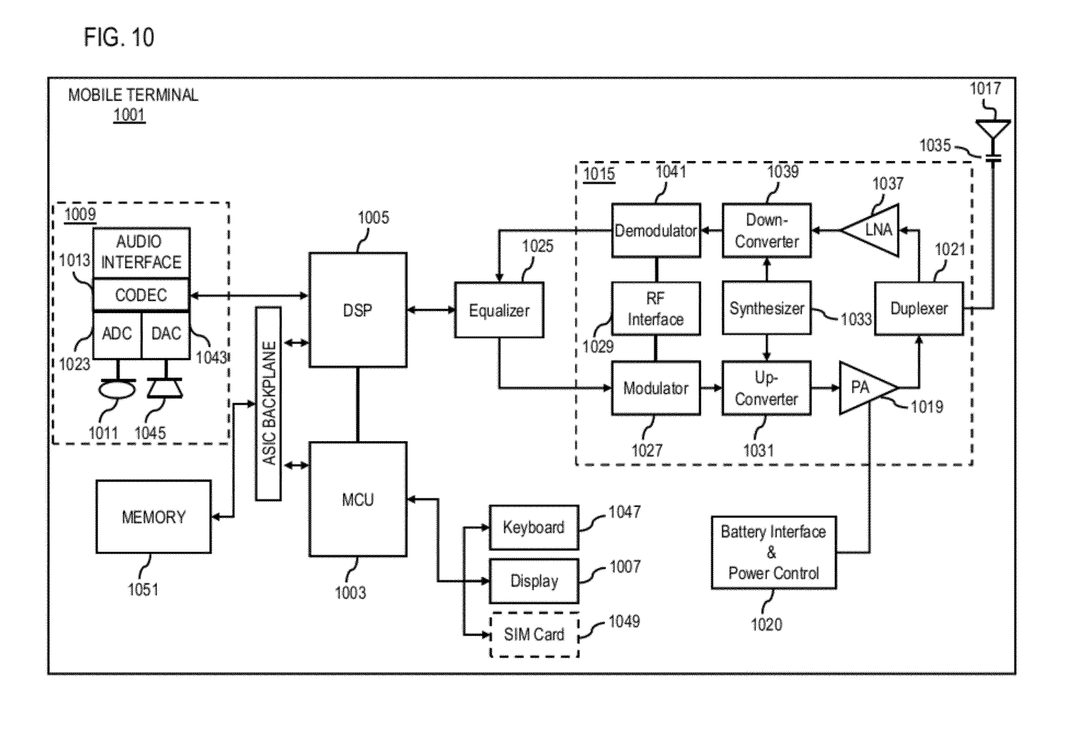

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of customizing device content. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of customizing device content. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to customize device content. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving an input for specifying one or more content items for a device;
determining to detect the device; and
determining to initiate installation of the one or more content items at the device based, at least in part, on the detection.

2. A method of claim 1, further comprising:
determining to associate the one or more content items with an account associated with the device; and
receiving a notification that the account is active over a network,
wherein the detection of the device is based, at least in part, on the notification.

3. A method of claim 1, wherein the initiation of the installation comprises at least in part:
determining to transmit the one or more content items to the device.

4. A method of claim 1, wherein the initiation of the installation comprises:
determining to transmit one or more links to the one or more content items to the device; and
determining to cause at least in part actions that result in retrieval and the installation of the one or more content items at the device.

5. A method of claim 4, further comprising:
determining one or more characteristics of the one or more content items; and
determining whether to transmit the one or more links or to transmit the one or more content items is based, at least in part, on the one or more characteristics.

6. A method of claim 1, further comprising:
determining to generate a user interface for presenting one or more options associated with the specifying of the one or more content items; and
determining to request via the user interface approval information for the installation, wherein the input includes, at least in part, the approval information.

7. A method of claim 1, wherein the initiation of the installation, the installation, or a combination thereof is performed without generating a notification to a user of the device.

8. A method of claim 1, wherein the input is received on a sale, an activation, a remote management event, or a combination thereof of the device.

9. An apparatus comprising:
at least one processor; and
at least one memory including computer program code for one or more programs,
the at least one memory and the computer program code configured to, with the at least one processor, cause the apparatus to perform at least the following,
receive an input for specifying one or more content items for a device;
determine to detect the device; and
determine to initiate installation of the one or more content items at the device based, at least in part, on the detection.

10. An apparatus of claim 9, wherein the apparatus is further caused to:
determine to associate the one or more content items with an account associated with the device; and
receive a notification that the account is active over a network,
wherein the detection of the device is based, at least in part, on the notification.

11. An apparatus of claim 9, wherein the apparatus is further caused to:
determine to transmit the one or more content items to the device.

12. An apparatus of claim 9, wherein the apparatus is further caused to:
determining to transmit one or more links to the one or more content items to the device; and
determining to cause at least in part actions that result in retrieval and the installation of the one or more content items at the device.

13. An apparatus of claim 12, wherein the apparatus is further caused to:
determining one or more characteristics of the one or more content items; and
determining whether to transmit the one or more links or to transmit the one or more content items is based, at least in part, on the one or more characteristics.

14. An apparatus of claim 9, wherein the apparatus is further caused to:
determining to generate a user interface for presenting one or more options associated with the specifying of the one or more content items; and
determining to request via the user interface approval information for the installation,
wherein the input includes, at least in part, the approval information.

15. An apparatus of claim 9, wherein the initiation of the installation, the installation, or a combination thereof is performed without generating a notification to a user of the device.

16. An apparatus of claim 9, wherein the input is received on a sale, an activation, a remote management event, or a combination thereof of the device.

17. A computer-readable storage medium carrying one or more sequences of one or more instructions which, when executed by one or more processors, cause an apparatus to at least perform the following steps:
receiving an input for specifying one or more content items for a device;
determining to detect the device; and
determining to initiate installation of the one or more content items at the device based, at least in part, on the detection.

18. A computer-readable storage medium of claim 17, wherein the apparatus is caused to further perform:
determining to associate the one or more content items with an account associate with the device; and
receiving a notification that the account is active over a network,
wherein the detection of the device is based, at least in part, on the notification.

19. A computer-readable storage medium of claim 17, wherein the apparatus is caused to further perform:
determining to transmit the one or more content items to the device.

20. A computer-readable storage medium of claim 17, wherein the apparatus is caused to further perform:
determining to transmit one or more links to the one or more content items to the device; and
determining to cause at least in part actions that result in retrieval and the installation of the one or more content items at the device.

21-43. (canceled)
